(19) United States
(12) Patent Application Publication
(10) Pub. No.: US 2005/0211776 A1
(43) Pub. Date: Sep. 29, 2005

(54) Method and system for providing a mail stamp unit assembly with tracking code

(76) Inventors: Ray H. Morgan, Williamsburg, VA (US); Gerald J. Jamula, Washington, DC (US)

Correspondence Address: FINNEGAN, HENDERSON, FARABOW,;GARRETT & DUNNER, L.L.P., 1300 I Street, N.W., Washington, DC, 20005, US

(21) Appl. No.: 10/952,820

(22) Filed: Sep. 30, 2004

Related U.S. Application Data
(60) Provisional application No. 60/525,829, filed on Dec. 1, 2003.

(30) Foreign Application Priority Data
Sep. 30, 2004 (WO) PCT/US04/32329

(51) Int. Cl. G06F 17/60; G07G 1/00; G06K 19/06

(52) U.S. Cl. 235/385; 235/101; 235/491

(57) ABSTRACT

A method of providing a stamp unit assembly with a tracking code comprising the steps of receiving a roll of stamp unit assemblies, providing the roll to a printer, applying a tracking code to each individual stamp in the roll of stamp unit assemblies using the printer, and separating the roll of stamp unit assemblies into individual mail stamp unit assemblies. The tracking code, in combination with a database having other codes associated with stages of the distribution of the stamp allows the vendor of the stamp to be determined from an inspection of the stamp.

### CROSS REFERENCE TO RELATED APPLICATION

This application claims priority to U.S. Provisional Application No. 60/525,829 filed Dec. 1, 2003, entitled “Method and System for Providing a Mail Stamp Unit Assembly with Tracking Code,” the contents of which are incorporated by reference herein.

### FIELD OF THE INVENTION

This invention relates generally to affixing a tracking code on postage stamps.

### BACKGROUND OF THE INVENTION

Presently there is no means to determine where a stamp was purchased. However, there are sometimes forensic reasons to identify the place where a given stamp was purchased. It is therefore desirable to provide systems and methods to allow appropriately appropriate entities to identify the point of sale where specific stamps were purchased.

It is accordingly a primary object of the invention to provide a method of tracking a postage stamp from its manufacture to the ultimate user so that the identity of the entity that sold the stamp to the user or the user themselves can be determined.

This is achieved by providing a tracking number on the stamp and, at the various stages of the distribution of the stamp inputting various codes into a database that can relate the codes to various entities in the distribution of the stamp.

### SUMMARY OF THE INVENTION

In accordance with the invention, there is provided a method of providing a stamp unit assembly with a tracking code comprising the steps of receiving a roll of stamp unit assemblies, providing the roll to a printer, applying a tracking code to each individual stamp in the roll of stamp unit assemblies using the printer; and separating theroll of stamp unit assemblies into individual mail stamp unit assemblies.

In another embodiment there is provided A method of tracking postage stamps comprising the steps of applying a tracking code to each individual stamp in an individual mail stamp unit assembly, assigning a manifest code to a shipment of individual mail stamp unit assemblies, printing the manifest code, attaching the printed manifest code to the shipment; and entering the tracking code and the manifest code into a database system capable of correlating the tracking code with the manifest code.

In still another embodiment the method further includes the step of scanning the individual stamp, reading the tracking code and determining the vendor by accessing the database containing the manifest code, the vendor code, and the tracking code.

In such a manner it is possible to determine from information on an individual stamp, the distribution center that distributed it and the vendor to whom the stamp was sent. If the vendor tracked the stamp to an individual purchaser, then the purchaser of any particular stamp having a tracking code thereon could be determined.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is a schematic view of a roll of mail stamps as it appears after printing of a tracking code.

FIG. 2 is a schematic view of a mail stamp, including a tracking code and an image.

FIG. 3 is a flowchart of a process for printing a tracking code on the mail stamps.

FIG. 4 is a flowchart of a process for creating a mail stamp unit assembly.

FIG. 5 is a flowchart of a process for creating a cross-reference index.

FIG. 6 is a flowchart of a process for preparing mail stamp unit assemblies for shipment to vending outlets for retail sale.

FIG. 7 is a flowchart of a process for de-coding the tracking code of the stamp on a suspicious piece of mail.

FIG. 8 is a table reflecting an exemplary database structure to enable cross-reference analysis of tracking, stamp, manifest, and vendor code.

### DESCRIPTION OF THE EMBODIMENTS

Reference will now be made in detail to an embodiment of the invention, an example of which is illustrated in the accompanying drawings.

Mail stamps are generally not packaged individually, but rather as a part of a “mail stamp unit assembly.” A mail stamp unit assembly may be, for example, a stamp coil, a set of pre-stamped envelopes, a stamp booklet, or a stamp sheet. This level of specificity is sufficient to identify the mail stamp unit assembly to the retail outlet where the stamps in that mail stamp unit assembly were sold.

To provide an ability to identify a point of purchase for each mail stamp after use, a manufacturer may print a tracking code on each individual mail stamp. Since the mail stamp unit assembly is usually not broken up amongst different retail outlets, a manufacturer may print the same tracking code on each mail stamp within the same mail stamp unit assembly. In alternative embodiment, each individual mail stamp within mail stamp unit assembly may receive its unique discrete tracking code.

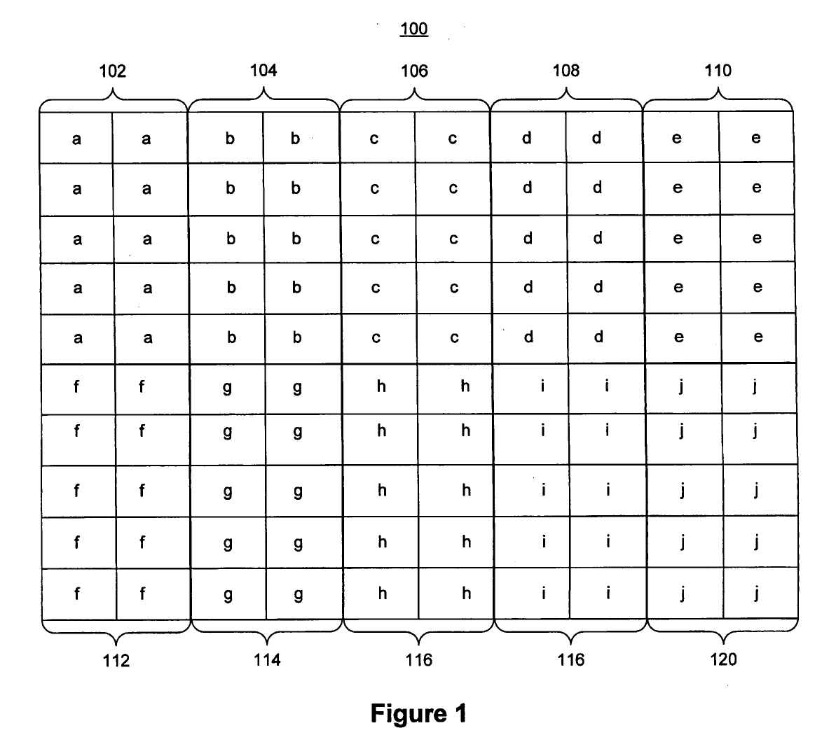

FIG. 1 is a schematic view of a roll 100 of mail stamps as it appears immediately after printing of a tracking code. In this schematic, roll 100 will supply stamps for ten different mail stamp unit assemblies 102, 104, 106, 108, 110, 112, 114, 116, 118, and 120. Each of mail stamp unit assemblies 102, 104, 106, 108, 110, 112, 114, 116, 118, and 120 will be sold as books of ten stamps. In alternative embodiment, roll 100 may supply stamps for mail stamp unit assemblies to be sold as stamp coils. In yet another embodiment, roll 100 may supply stamps for mail stamp unit assemblies to be sold as pre-stamped envelopes or stamp sheets.

Stamps of each mail stamp unit assembly are printed with a respective tracking code. As indicated, a tracking code of a is printed on stamps of mail stamp unit assembly 102, a tracking code of b is printed on stamps of mail stamp unit assembly 104, a tracking code of c is printed on stamps of mail stamp unit assembly 106, a tracking code of d is printed on stamps of mail stamp unit assembly 108, a tracking code of e is printed on stamps of mail stamp unit assembly 110, a tracking code of f is printed on stamps of mail stamp unit assembly 112, a tracking code of g is printed on stamps of mail stamp unit assembly 114, a tracking code of h is printed on stamps of mail stamp unit assembly 116, a tracking code of i is printed on stamps of mail stamp unit assembly 118, and a tracking code of j is printed on stamps of mail stamp unit assembly 120. Of course, FIG. 1 is a schematic only, and a roll may include more or fewer stamps than indicated in FIG. 1. Likewise, the alpha characters represent alpha, numeric, or alphanumeric codes of sufficient discreteness to allow unique identification of stamps in each mail stamp unit assembly. The number of mail stamp unit assemblies required per unit of time will determine the configuration of the codes and the timeframe required before codes are reused. After printing, stamps of each mail stamp unit assembly are separated from roll 100 and packaged, as appropriate. For example, stamps of mail stamp unit assemblies 102, 104, 106, 108, 110, 112, 114, 116, 118, and 120 may be separated and bound into books. In alternative embodiments, stamps of mail stamp unit assemblies may be rolled into coils and packaged into plastic dispenser packs. In yet another embodiment, stamps of mail stamp unit assemblies may be separated and packaged in sets of pre-stamped envelopes or stamp sheets.

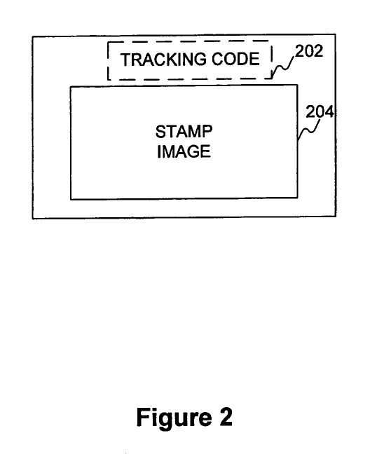

FIG. 2 shows a mail stamp 200, including a tracking code 202 and an image 204. A manufacturer may print tracking code 202 on the margins of the stamp, between image 204 and an edge. For example, tracking code 202 may be printed as one line, centered above image 204 as shown on FIG. 2. In alternative embodiments, tracking code 202 may be located in any of the four margins around the image of the stamp, centered or not with respect to the image of the stamp. In yet another embodiment, tracking code 202 may be printed partially in the margins and partially overlapping image 204, or printed totally within image 204.

Rolls 100 may include different numbers of mail stamp unit assemblies. For example, one roll may include thirty mail stamp unit assemblies, each in the form of a 100-stamp sheet, configured 10×10. Such a roll 100 will include thirty different tracking codes, one for each sheet.

A manufacturer may begin the process of printing mail stamps by receiving a roll of paper from an outside vendor. Then, the manufacturer may print stamp images 204 on the roll. For example, a popular image for the stamp booklets is the American flag. The pattern of the images within roll 100 is consistent with a size and a layout of targeted mail stamp unit assemblies a manufacturer intends to make. A manufacturer then subjects results of that printing to a quality control process and detaches portions of the roll containing defective stamps.

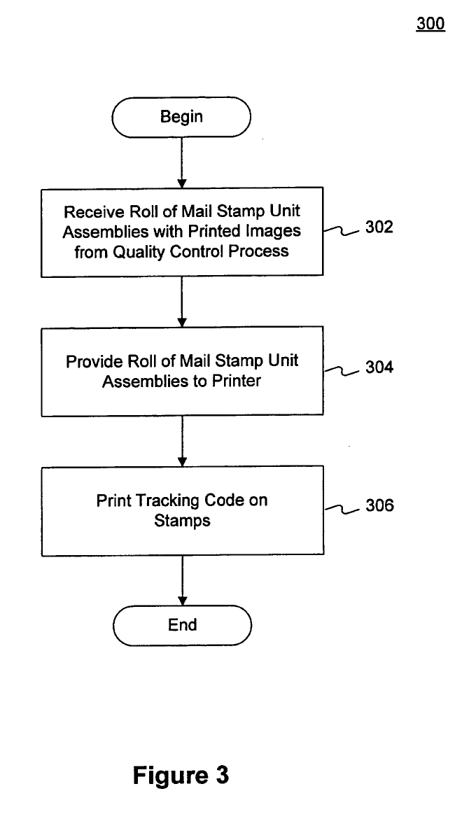

FIG. 3 is a flowchart of a process 300 for printing a tracking code on the mail stamps. It may include receiving a roll of mail stamp unit assemblies from quality control process (step 302). A manufacturer then provides a roll of mail stamp unit assemblies to a printer (step 304). Tracking codes may be printed on stamps of roll 100 (step 306). A manufacturer may print with fluorescent, phosphorescent, pigmented, or non-pigmented ink including fluorescent or phosphorescent markers. Printing of the tracking code may occur after images are printed on the stamps. In another example, tracking codes 202 are placed on stamps using nano-printing technology. In various embodiments, tracking codes 202 may be either visible or invisible via normal visual inspection. A tracking code may include any combination of letters, numbers, bar codes, 2-Dimensional codes, any appropriate data glyph, or any symbols and their modifications required to establish a unique code for each mail stamp unit assembly.

In an alternative embodiment, tracking codes may be printed on stamps in a separate operation after separating roll 100 into mail stamp unit assemblies, but before packaging. The process may include quality control operations for inspecting printed tracking codes for quality and accuracy of placement. For example, a manufacturer may inspect each stamp or selective stamps to confirm that the tracking code is un-smeared, readable, and fully present on each stamp.

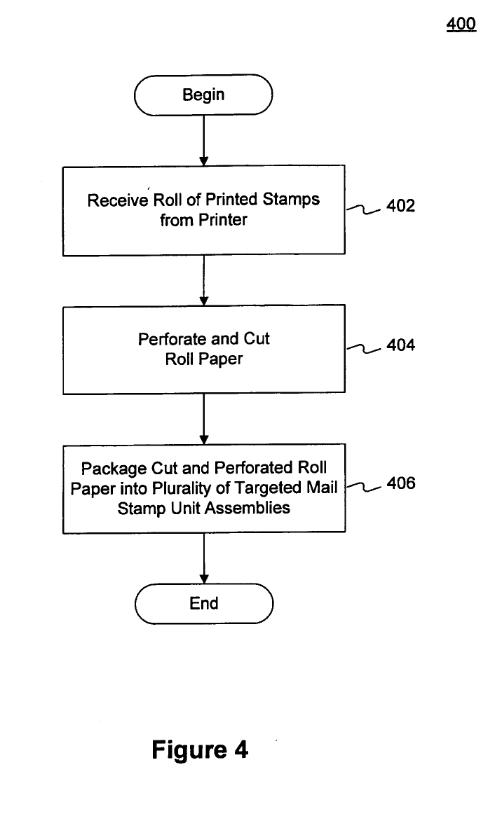

Once the tracking code is printed on the stamps, a manufacturer may continue a process for creating a mail stamp unit assembly. FIG. 4 is a flowchart of an exemplary process 400 for creating a mail stamp unit assembly. It may include the step of receiving a roll of printed stamps from a printer (step 402). The process then perforates and cuts (preferably simultaneously) the roll paper into sub-units (step 404). The size and shape of the sub-units depends upon the configuration of the desired mail stamp unit assembly. For example, to create a mail stamp unit assembly in the form of a stamp sheet, the roll paper is cut and perforated into a plurality of flat sheets, each containing, for example, one hundred stamps configured 10×10 or one hundred forty four stamps configured 12×12. The process then may package the cut and perforated roll paper into a plurality of targeted mail stamp unit assemblies, such as stamp coils, sets of pre-stamped envelopes, stamp booklets, or stamp sheets (step 406).

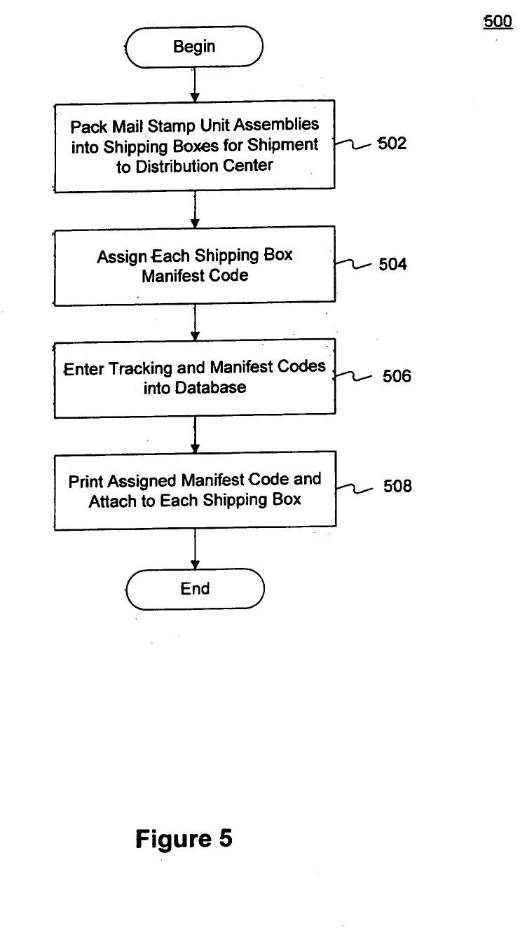

Once mail stamp unit assemblies are packaged and ready for sale, a process may be performed to create a cross-reference index for each mail stamp unit assembly to enable future identification of a point of sale. FIG. 5 is a flowchart of a process 500 for creating a cross-reference index. A manufacturer may pack ready-for-sale packaged mail stamp unit assemblies into shipping boxes for shipment to a Distribution Center (step 502). The number of mail stamp unit assemblies included in each shipping box may vary, based on the size and shape of assemblies and the size of the shipping box. The manufacturer then assigns each shipping box a manifest code corresponding to the tracking codes of the mail stamp unit assemblies contained in that shipping box (step 504). This correspondence relationship may be maintained in an external database or carried within the manifest code. The manifest code may be a type of bar code or any other appropriate identification system. The manufacturer then enters the tracking and manifest codes into a database system maintaining a cross-reference between manifest codes of the shipping boxes and tracking codes of all mail stamp unit assemblies contained in corresponding shipping boxes (step 506). The manufacturer then may print the assigned manifest code and attach it to each shipping box (step 508). A manifest code may include any appropriate combination of letters, numbers, symbols, bar codes, 2-Dimensional codes, or other data glyph.

In an alternative embodiment, in addition to the tracking code printed on each stamp, the manufacturer may also assign a stamp code, not printed on the stamps or on the shipping box, to each mail stamp unit assembly. The manufacturer then enters the stamp code into the database system along with corresponding tracking and manifest codes to provide additional cross-reference capability.

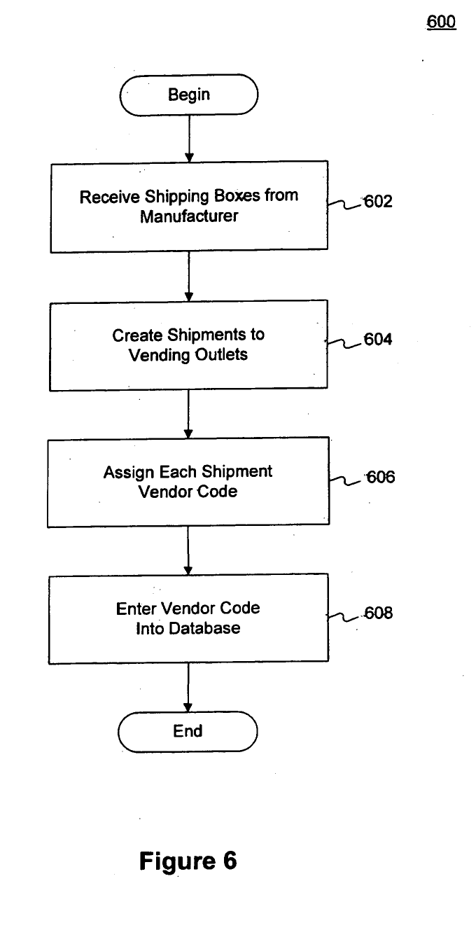

FIG. 6 shows a process 600 for preparing mail stamp unit assemblies for shipment to vending outlets for retail sale. A Distribution Center receives shipping boxes from the manufacturer (step 602). It then prepares mail stamp unit assemblies for shipment to vending outlets. A Distribution Center may create separate shipments to each vending outlet where individual mail stamp unit assemblies will be sold (step 604). In another example, creating of separate shipments may include opening some shipping boxes and dividing their contents into separate portions (not shown). For example, a Distribution Center may open and divide contents of the shipping box when the amount of mail stamp unit assemblies in one shipping box exceeds the amount of the mail stamp unit assemblies to be shipped to a particular vending outlet. The Distribution Center then assigns to each shipment a vendor code corresponding to the vending outlet where that shipment will be sent for sale (step 606). A vendor code may include any appropriate combination of letters, numbers, symbols, bar codes, 2-Dimensional codes, or other data glyph. The vendor code is then entered into the database system (step 608). Indeed, the vendor code is tied in the database system to previously entered manifest and tracking codes of the corresponding mail stamp unit assemblies.

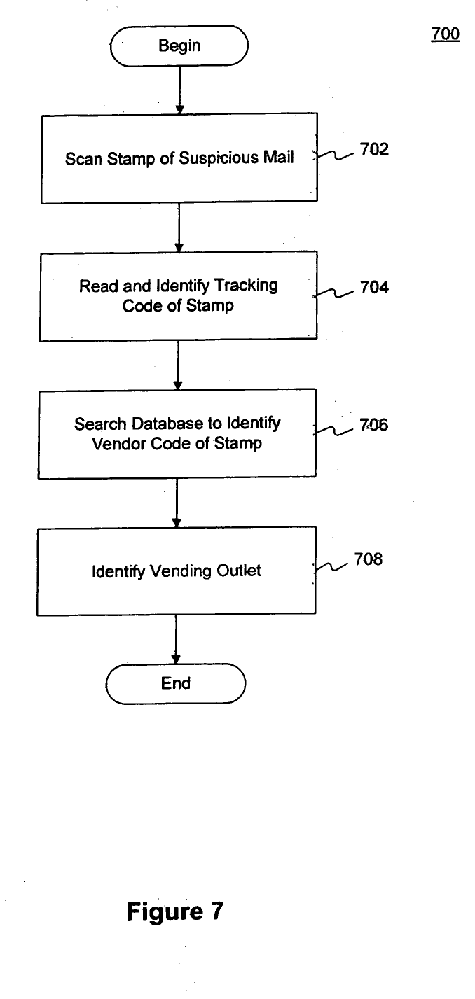

FIG. 7 is a flowchart of a process 700 for de-coding the tracking code of the stamp for which a point of sale location is desired. The first step is to scan the stamp on that piece of mail (step 702). More than one method of scanning may be used, depending on the type of process used to affix the tracking code to the stamp. Information obtained from the scanning step is used to read and identify the tracking code of the stamp (step 704). Then, the database system is searched to identify the vendor code of the stamp corresponding to the tracking code read with the scanning device (step 706). The vendor code allows identification of the vending outlet where the mail stamp in question was sold and purchased (step 708).

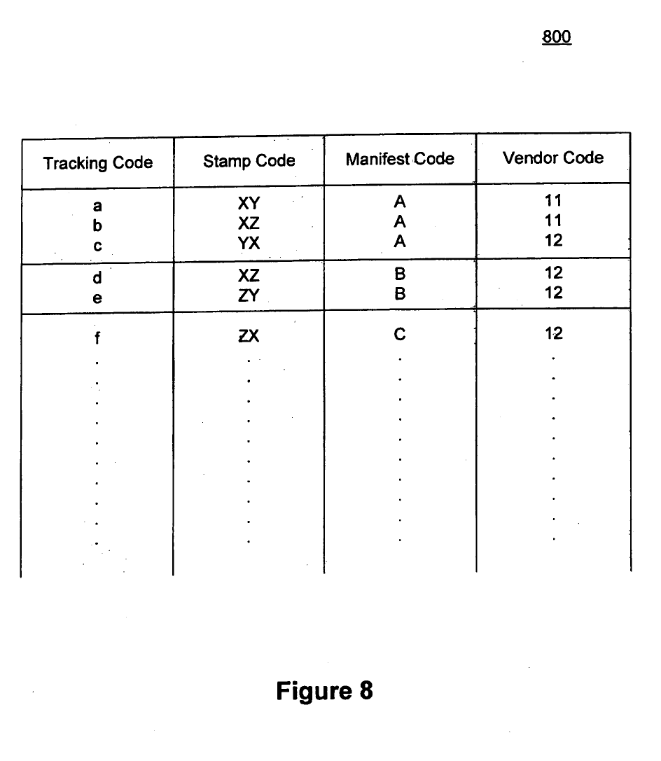

FIG. 8 depicts a table reflecting an exemplary database structure to enable cross-reference analysis of tracking, stamp, manifest, and vendor codes. For example, tracking codes a, b, c, etc. in table 800 represent the tracking codes printed on individual stamps. In addition, a manufacturer may assign to each mail stamp unit assembly a stamp code. For example, XY and XZ stamp codes respectively correspond to tracking codes a and b for additional cross-reference purposes. A manufacturer may also assign a manifest code to each shipping box it packs. A manifest code assigned to a shipping box allows cross-referencing and identification of each mail stamp unit assembly contained in that shipping box. For example, manifest code A (see FIG. 8) is assigned to a shipping box containing mail stamp unit assemblies with tracking codes a, b, and c. Manifest code B is assigned to a shipping box containing mail stamp unit assemblies with tracking codes d and e. After a Distribution Center creates a shipment to a vending outlet, it adds a vendor code to table 800. The shipment may include mail stamp unit assemblies with tracking codes a and b. For example, vendor code 11 is assigned to a shipment created from a portion of a shipment box with manifest code A. Indeed, vendor code 11 also represents a cross-reference to a specific vending outlet where the shipment will be sent for sale. In another example, vendor code 12 is assigned to a shipment created from several shipping boxes with manifest codes A, B, and C. For example, the entire contents of the shipping box with manifest code B and portions of the shipping boxes with manifest codes A and C will be shipped to the same vendor with assigned vendor code 12.

One skilled in the art will recognize that many alternative embodiments are possible. For example, a manufacturer may execute the quality control process of the printed tracking code at any time after printing the tracking code, but prior to packing mail stamp unit assemblies in shipping boxes. In yet another example, a manufacturer and a Distribution Center may enter tracking, stamp, manifest, and vendor codes into database system at any time as long as accuracy of the entered information is not jeopardized.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of providing a stamp unit assembly with a tracking code comprising:
receiving a roll of stamp unit assemblies;
providing said roll to a printer;
applying a tracking code to each individual stamp in said roll of stamp unit assemblies using said printer; and
separating said roll of stamp unit assemblies into individual mail stamp unit assemblies.

2. The method of claim 1 wherein said tracking code comprises either: numbers, letters, combinations of numbers and letters, a bar code, a two-dimensional code, a data glyph, or a symbol.

3. The method of claim 1 wherein said tracking code is printed with either: fluorescent, phosphorescent, pigmented, or non-pigmented ink.

4. The method of claim 1 wherein said tracking code includes fluorescent or phosphorescent markers.

5. The method of claim 1 wherein said tracking code is printed using nano-printing technology.

6. The method of claim 1 wherein said individual mail stamp unit assemblies comprise a sheet of mail stamps.

7. The method of claim 1 wherein said individual mail stamp unit assemblies comprise a coil of mail stamps.

8. The method of claim 1 wherein said individual mail stamp unit assemblies comprise a book of mail stamps.

9. The method of claim 1 including the step of assigning a stamp code for each individual stamp, said stamp code being nowhere recorded on said mail stamp.

10. A method of tracking postage stamps comprising:
applying a tracking code to each individual stamp in an individual mail stamp unit assembly;
assigning a manifest code to a shipment of individual mail stamp unit assemblies;
printing said manifest code;
attaching said printed manifest code to said shipment; and
entering said tracking code and said manifest code into a database system capable of correlating said tracking code with said manifest code.

11. The method of claim 10 including the step of sending said shipment to a distribution center.

12. The method of claim 11, wherein said distribution center assigns a vendor code for the vendor which will received said shipment.

13. The method of claim 10 wherein said vendor code comprises either: numbers, letters, combinations of numbers and letters, a bar code, a two-dimensional code, a data glyph, or a symbol.

14. The method of claim 13, wherein said vendor code is input to said database.

15. The method of claim 14, said database being capable of relating said tracking code, said manifest code, and said vendor code.

16. The method of claim 10 including the step of scanning the individual stamp, reading the tracking code and determining the vendor by accessing the database containing the manifest code, the vendor code, and the tracking code.

17. The method of claim 10 wherein said manifest code comprises either: numbers, letters, combinations of numbers and letters, a bar code, a two-dimensional code, a data glyph, or a symbol.

18. The method of claim 10 including the step of assigning a stamp code for each individual stamp, said stamp code being nowhere recorded on said mail stamp and entering said stamp code in said database.

19. The method of claim 10 including the step of scanning the individual stamp, reading the tracking code and determining the vendor by accessing the database containing the manifest code and the tracking code.
